(19) United States
(12) Patent Application Publication
(10) Pub. No.: US 2006/0137942 A1
(43) Pub. Date: Jun. 29, 2006

(54) Wheelchair wheel lock

(76) Inventor: David M. Counts, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/262,202

(22) Filed: Oct. 28, 2005

Related U.S. Application Data
(60) Provisional application No. 60/623,377, filed on Oct. 28, 2004.

(51) Int. Cl. B62B 5/04

(52) U.S. Cl. 188/2 F; 188/2 D

(57) ABSTRACT

A locking device for a wheelchair wheel configured to prevent the locking assembly being stuck in a locked condition when the wheel abuts another object. The locking assembly comprises a base plate mounted on the wheelchair frame adjacent a locking rotor attached to the wheel hub, a locking pin for engagement with one of a plurality of locking apertures on the locking rotor and a cam mechanism on the base plate that extends and retracts the locking pin from engagement with the rotor. The cam mechanism comprises a lock stub mounted on the base plate that receives the locking pin in one end thereof and a lock lever pivotally mounted on the opposite end thereof. The lock stub has a cam path in which a cam follower pin, attached to the lock lever, travels to extend or retract the locking pin outward from the base plate towards the locking rotor.

### CROSS-REFERENCE TO RELATED APPLICATIONS

This application claims the benefit of U.S. Provisional Application No. 60/623,377 filed Oct. 28, 2004.

### BACKGROUND OF THE INVENTION

A. Field of the Invention

The field of the present invention relates generally to locking mechanisms used to securely lock a wheelchair wheel so as to prevent movement of the wheelchair. In particular, the present invention relates to such wheelchair wheel locking mechanisms that are configured to prevent the wheel lock from being stuck in the locked condition when it is desired to move the wheelchair. Even more particularly, this invention relates to such wheelchair wheel locks that utilize a rotating pin and cam system to unlock the wheel and which provide a more compact unit when the wheelchair is folded.

B. Background

The primary purpose of a wheelchair is to provide a safe and relatively convenient means of mobility to persons who may otherwise not be mobile or have very limited mobility. The person in the wheelchair often needs or desires the wheelchair to remain stationary, for instance when he or she is getting in or out of the wheelchair. The many advances in wheelchair technology have generally resulted in wheelchairs that require less effort to move, which is very beneficial when wheelchair movement is desired but less so when the wheelchair must remain stationary. As a result, wheelchair manufacturers have had to develop improved braking and wheel locking mechanisms to stop the wheelchair or to prevent movement of the wheelchair when being stationary is desired. With regard to wheelchair wheel locking mechanisms, the mechanism must be configured to securely lock the wheelchair wheel when it is engaged so that the wheelchair does not move, particularly when the occupant of the wheelchair desires to get in or out of the wheelchair. As can be envisioned, movement of wheelchair when it is desired that it be stationary can result in potentially serious injury to the user, such as would occur from falling as he or she tries to get in or out of the wheelchair.

The use of wheelchair locking mechanisms are well known and a number of such mechanisms are described in the prior art. For example, U.S. Pat. No. 5,799,756 to Roberts, et al. describes wheelchair wheel lock comprising a slotted disc, which is mounted on the hub of a wheel, that has a plurality of tapered slots on the outer perimeter of the disc which are configured to accept a correspondingly configured tapered latch. The locking component pivots the latch into a slot to lock the wheel and then out of the slot to unlock the wheel. U.S. Pat. No. 6,308,804 to Roberts describes a wheelchair wheel lock comprising a locking disc, mounted to the wheel hub, that has a plurality of chamfered holes and a locking component that includes a spring driven tapered pin that is configured to be driven into a hole on the disc to lock the wheel in place and then withdrawn to allow movement of the wheel. U.S. Pat. No. 6,341,671 to Ebersole describes a wheelchair wheel lock comprising a hub mounted disc having a plurality of apertures and locking component that includes a spring driven plunger that is driven into one of the apertures to lock the wheel and removed therefrom to unlock the wheel. Action of a lever causes a cable interconnecting the lever and the plunger assembly to operate the plunger, which has a beveled distal end to facilitate entry into an aperture. U.S. patent application Publication No. 20040099487 to Melgarejo comprises a wheel hub mounted locking ring that has a plurality of dog receiving cages that are each provided with an opening into which a spring-driven dog, having tapered sidewalls, is inserted. In the Melgarejo mechanism the locking ring is axially aligned with the wheel hub, whereas in the forgoing patents the locking disc is generally perpendicular to the axis of the wheel hub.

Although the foregoing and other prior art wheel lock devices are generally able to suitably place a wheelchair wheel in a locked condition, they all suffer from a well known and heretofore not sufficiently addressed problem, namely that under certain conditions it is very difficult to operate the locking mechanism to unlock the wheelchair wheel. It is well known that many wheelchair users frequently desire to locate the wheelchair as close as possible to a table, bed or other object. Generally, this results in the wheel making contact with the object. When the wheelchair wheel is pushed against such an object, it can be very difficult for the wheelchair bound person to operate the locking mechanism so as to unlock the wheel and allow movement of the wheelchair. Under such circumstances, the straight action movement of the prior art wheelchair wheel locks, including those described above, often gets stuck in place due to the pressure of the side of the slot, hole, aperture or other opening (collectively, the “hole”) against the spring-driven pin, plunger, dog or other locking member (collectively, the “pin”). Because of the pressure of the wheelchair wheel against the object, the locking component cannot sufficiently move to withdraw the pin from the hole to unlock the locking mechanism and allow the desired movement of the wheel.

Another problem common with the prior art wheelchair wheel locks is that the pin driven locking mechanisms require that the pin be sufficiently spaced from the hole so that it can move in and out of the hole to lock or unlock the wheel. As a result of this spacing requirement, the typical wheelchair wheel lock effectively extends the width of the wheelchair. When the wheelchair is folded for movement or storage, the additional width resulting from the wheelchair wheel lock mechanism can be relatively significant and undesirable.

What is needed is an improved wheelchair wheel lock that solves the problem of the stuck wheelchair wheel lock that prevents unlocking of the wheel when the wheel is pushed against another object, a problem experienced by many users of wheelchairs. What is also needed is a wheelchair wheel lock that does not significantly increase the effective width of the wheelchair. The preferred wheelchair wheel lock will allow the user to easily unlock the wheel even when the wheel is pushed against an object and will reduce the width of the wheelchair for improved ease of moving or storing when folded. The preferred wheelchair wheel lock should comprise a wheel hub mounting disc having a plurality of holes thereon and a spring-driven locking pin that is disposed in a housing having a cam path in which a cam follower pin moves to move the locking pin in or out of the holes to lock or unlock the wheel. In this configuration, the locking pin is rotated in and out of the hole to lock or release the wheel hub instead of being directly driven in and out of the hole, as with the prior art wheelchair wheel locks, so as to prevent the pin being stuck in the hole when pressure is applied to the wheelchair wheel.

### SUMMARY OF THE INVENTION

The wheelchair wheel lock of the present invention provides the benefits and solves the problems identified above. That is to say, the present invention discloses a wheelchair wheel lock that prevents the locking pin from getting stuck in one of the holes on the hub mounted disc by providing a mechanism that utilizes a rotation action to cause the locking pin to move into and out of the hole. The present invention also reduces the width of presently available wheelchair wheel lock assemblies so as to make it easier to move and store the folded wheelchair. The present invention is adaptable to many types of wheelchairs and can be included with a new wheelchair or adapted to retrofit an existing wheelchair.

In one general aspect of the present invention, the wheelchair wheel lock comprises a lock operating mechanism attached to the wheelchair at a place where it can be operated by an occupant of the wheelchair, a locking assembly at a wheel of the wheelchair, a cable interconnecting the lock operating mechanism with the locking assembly and a locking rotor attached to the hub of the wheel. The lock operating mechanism has a handle, which the user operates to lock or unlock the wheel, attached to a first end of the cable. The second end of the cable attaches to the locking assembly to engage or disengage the locking rotor and prevent or allow movement of the wheel. In the preferred embodiment, the locking rotor has a plurality of locking apertures and the locking assembly comprises a locking pin having a first end that engages one of the plurality of locking apertures on the locking rotor. Also in the preferred embodiment, the locking assembly further comprises a base plate positioned substantially adjacent the locking rotor, a lock stub mounted on the base plate and a lock lever pivotally engaged with the lock stub. The second end of locking pin extends through an aperture in the base plate and into the second end of the lock stub to connect with the lock lever pivotally disposed over the first end of the lock stub. The lock stub has a cam path disposed on the side thereof and the lock lever has a cam follower pin received in the cam path. The cam path is configured such that pivotal movement of the lock lever, achieved by movement of the cable due to operation by the user, will extend or retract the first end of the locking pin so that it will either engage one of the locking apertures to lock the wheel to prevent movement of the wheelchair or disengage from the locking aperture to unlock the wheel so as to allow movement of the wheelchair. In the preferred embodiment, the plane of the base plate is substantially parallel to the plane of the locking rotor and the locking pin extends substantially perpendicular from the base plate.

In a second general aspect of the present invention, the locking assembly for a wheel lock, which is configured to lock a wheel of a wheelchair, has a base plate that is attached to the frame of the wheelchair and positioned substantially adjacent to a locking rotor that is attached to a hub of the wheelchair wheel. The locking rotor has a plurality of locking apertures. A lock stub, having a first end, a second end and a cam path on the side thereof, is fixed to the base plate. A locking, pin having a first end and a second end, is disposed in the second end of the lock stub, with the first end of the locking pin configured to operatively engage one of the plurality of locking apertures on the locking rotor. A lock lever is pivotally disposed about the first end of the lock stub and connected to the second end of the locking pin. The lock lever has a cam follower pin that is in cooperative engagement with the cam path, which is shaped and configured such that movement of the cam follower pin through the cam path will engage or disengage the first end of the locking pin with one of the plurality of the locking apertures. The cam follower pin moves through the cam path due to the pivotal movement of the lock lever about the lock stub, which movement results from operation of a cable connected to a lock operating mechanism mounted on the wheelchair at a place accessible by the person seated in the wheelchair.

Accordingly, the primary objective of the present invention is to provide an improved wheelchair wheel lock that provides the advantages discussed above and overcomes the disadvantages and limitations which are associated with presently available wheelchair wheel locks.

An important objective of the present invention to provide a wheelchair wheel lock that prevents the problem of the locking mechanism being stuck in the locked condition when a wheelchair wheel is abutting an object, which is a common problem with the prior art wheelchair wheel locking mechanisms.

It is also an important objective of the present invention to provide a wheelchair wheel lock that prevents the problem of a locking pin being stuck in a hole on the wheel hub mounted rotor when a wheelchair wheel is abutting an object and it is desired to unlock the wheelchair for movement thereof.

It is also an important objective of the present invention to provide a wheelchair wheel lock that does not significantly increase the effective width of the wheelchair due to the amount of space needed to operate the wheel lock mechanism so as to not significantly increase the problems with moving or storing a folded wheelchair.

It is also an important objective of the present invention to provide a wheelchair wheel lock that utilizes a cable operated lever that engages a cam mechanism so as to rotate the locking pin in and out of receiving engagement with the locking rotor mounted to the wheel hub so as to selectively lock or unlock the wheel.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a perspective side view of a wheelchair wheel lock configured according to a preferred embodiment of the present invention mounted on a wheelchair frame;

FIG. 2 is an perspective side view of the upper clamp assembly and lever mechanism utilized in the embodiment shown in FIG. 1;

FIG. 3 is an exploded perspective side view of wheelchair wheel showing the positioning of the locking rotor an rotor backplate shown in FIG. 1;

FIG. 4 is a side view of the assembled base plate assembly and locking rotor of a wheelchair wheel lock configured according to the principles of a preferred embodiment of the present invention;

FIG. 5 is an exploded perspective view showing the various components that make up the base plate assembly and locking rotor of FIG. 4 with the locking rotor shown attached to the wheelchair wheel hub;

FIG. 6 is a perspective view showing an assembled base plate assembly as utilized in the embodiment of the wheelchair wheel lock shown in FIG. 1;

FIG. 7 is a partially exploded view of the components of FIG. 6 showing the lower lever assembly and separated from the locking stub to reveal the cam path and cam follower pin;

FIG. 8 is a perspective view of the base plate utilized with the embodiment of the wheelchair wheel lock of the present invention shown in FIGS. 1 and 7; and

FIG. 9 is a perspective view of the locking stub utilized with the embodiment of the wheelchair wheel lock of the present invention shown in FIGS. 1 and 7.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represents one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For purposes of this disclosure, references are generally to use of the present invention with a wheelchair, however, it is understood that the disclosure herein may apply to other types of devices having similar wheel locking needs.

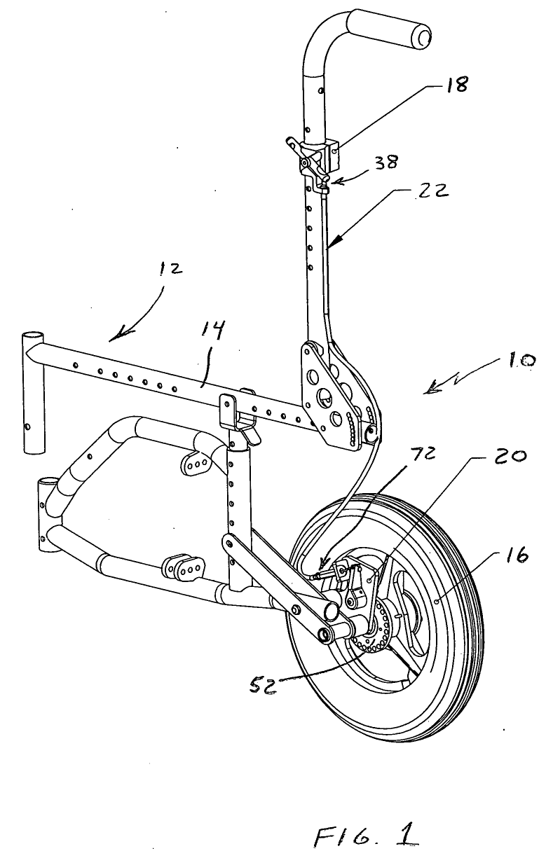

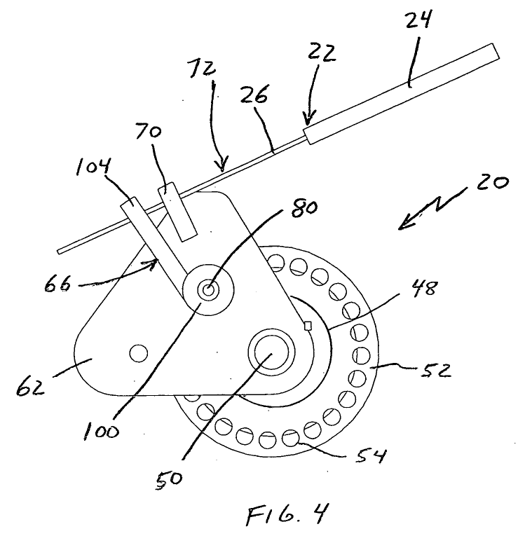

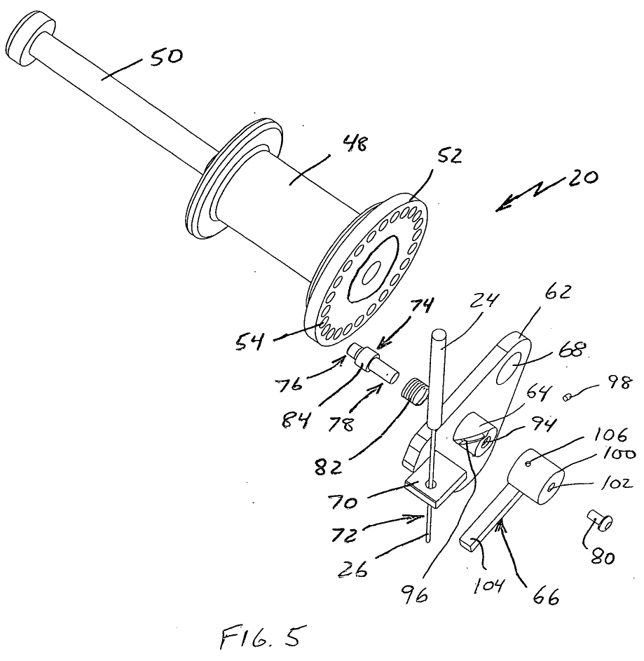

A wheelchair wheel lock that is manufactured out of the components and configured pursuant to a preferred embodiment of the present invention is shown generally as 10 in FIG. 1. As shown in FIG. 1, wheel lock 10 is adapted for use with a wheelchair, shown generally as 12, and is attached to frame 14 of wheelchair 12 to selectively lock or unlock wheel 16 so as prevent or allow movement of wheelchair 12. As with most prior art wheelchair wheel locks, the wheelchair wheel lock 10 of the present invention has lock operating mechanism 18, typically mounted to frame 14 and located at an upper portion of wheelchair 12 for easy access by the user of wheelchair 12 when he or she is sitting in the wheelchair seat (not shown), a locking assembly 20 located at a lower portion of wheelchair 12 near wheel 16 and a cable 22 interconnecting lock operating mechanism 18 and locking assembly 20. In the preferred embodiment, cable 22 is of the type having an outer sheathing 24 and a stiff inner wire member 26, as shown in FIGS. 4 and 5, that is configured to move freely within outer sheathing 24 in response to the operation of lock operating mechanism 18. Typically, the majority of cable 22 will be attached to or substantially attached to frame 14.

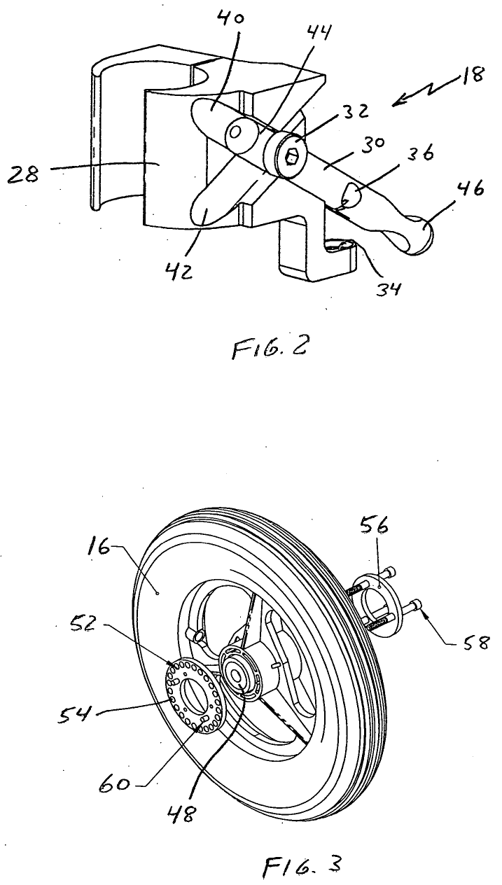

In a preferred embodiment, lock operating mechanism 18 comprises bracket 28 sized and configured to attach to an upper portion of frame 14, handle 30 pivotally attached to bracket 28 by pivot mechanism 32, cable support 34 on bracket 28 and a cable receiving aperture 36 in handle 30 for securely connecting to an upper or first end 38 of cable 22. In the embodiment shown in the FIGS. 1 and 2, bracket 28 also comprises a locked groove 40 and an unlocked groove 42 for receiving the first end 44 of handle 30 so as to maintain wheelchair wheel lock 10 in a locked condition or an unlocked condition, respectively. As will be readily understood by those skilled in the art, as the second end 46 of handle 30 in FIG. 2 is raised to place the first end 44 in unlocked groove 42, the inner wire member 26 is pulled and as the second end 46 of handle 30 is lowered to place first end 44 in locked groove 40, inner wire member 26 is pushed. As explained in more detail below, this pulling or pushing of inner wire member 26 results in locking assembly 20 being placed in an unlocked condition or a locked condition, respectively.

As shown in FIGS. 3 through 5, located at wheel 16 is wheel hub 48, which is cooperatively engaged with the axle 50 of wheelchair 14 to allow rotational movement of wheel 16. Positioned on or around wheel hub 48, and attached thereto, is locking rotor 52 having a plurality of locking apertures 54 circumferentially disposed around locking rotor 52. In the embodiment shown in the figures, particularly FIG. 3, a backing plate 56 is positioned on the opposite side of wheel 16 and connected to locking rotor 52 by one or more connecting mechanisms, such as bolts 58. The face of locking rotor 52 facing inward (i.e., toward frame 14), also comprises one or more spacing elements 60 thereon. When installed, locking rotor 52 will be attached to hub 48, such that it rotates with wheel 16 and when locking rotor 52 is locked, by the operation of locking assembly 20, wheel 16 will not move.

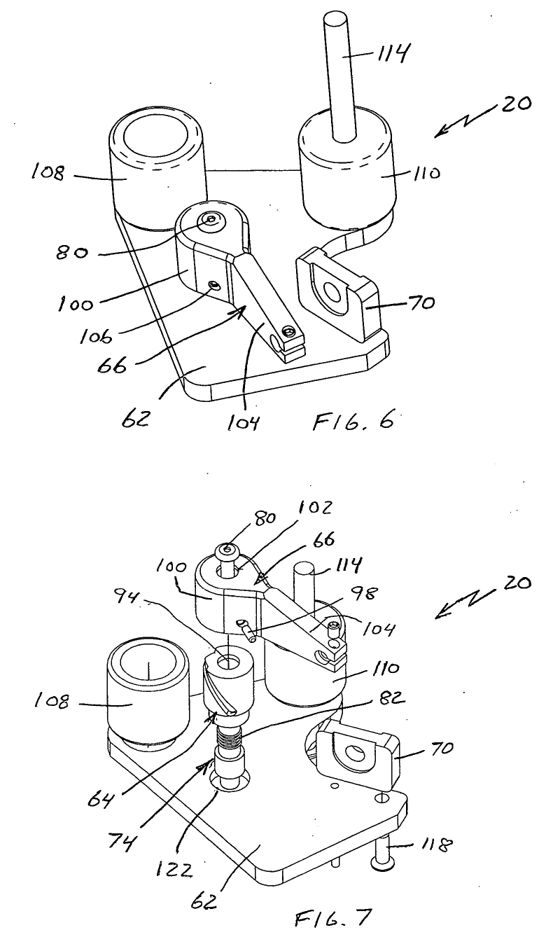

Locking assembly 20 is configured to selective engage one of the plurality of locking apertures 54 on locking rotor 52 to place wheelchair wheel lock 10 in the locked condition. In the preferred embodiment, best shown in FIGS. 4 through 9, locking assembly 20 comprises base plate 62 having a lock stub 64 mounted thereon, lock lever 66 cooperatively engaged with lock stub 64 (as set forth in more detail below), an axle cooperating aperture 68 for receiving an outer end of axle 18 and cable stand 70 attached thereto or mounted thereon for supporting the second end 72 of cable 22. Locking assembly 20 also comprises locking pin 74 having a first end 76 sized and configured to engage one of the plurality of locking apertures 54 on locking rotor 52 and a second end 78 connected to lock lever 66 with a connecting element, such as screw 80. In the preferred embodiment, as best shown in FIGS. 5 and 7, a spring 82 is disposed about the portion of locking pin 74 towards second end 78 and held in place by spring shoulder 84 so as to bias the first end 76 of locking pin 74 towards locking rotor 52. As shown in the figures, base plate 62 is substantially adjacent to locking rotor 52 and in a plane that is substantially parallel to the plane defined by the locking rotor 52, such that locking pin 74 extends outwardly from base plate 62 in a substantially perpendicular direction towards locking plate 62 and the locking apertures 54 thereon.

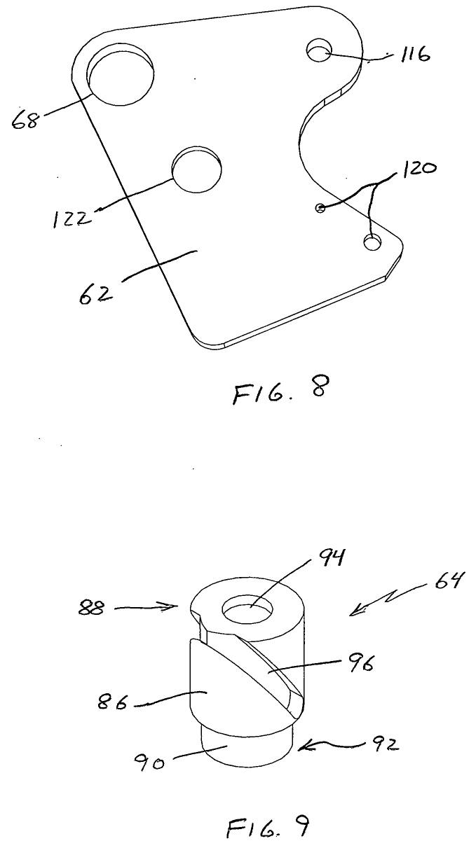

As best shown in FIG. 9, in a preferred embodiment of the present invention lock stub 64 has a main body portion 86 towards a first end 88 thereof and a reduced diameter portion 90 towards a second end 92 thereof. Aperture 94 is sized to receive connecting element 80 at the first end 88 of lock stub 64 and receive the second end 78 of locking pin 74 at the second end 92 of lock stub 64. Main body portion 86 of lock stub has a cam path 96 configured to receive cam follower pin 98 (as shown in FIGS. 5 and 7). Lock lever 66 comprises a lever body 100 having an opening (not shown) on one side that is sized and configured to receive lock stub 64 therein and an aperture 102 on the opposite side for receiving connecting element 80. Lock lever 66 also comprises a lever handle 104 that is configured to attach to the second end 72 of cable 22, as best shown in FIGS. 6 and 7. As shown in FIGS. 5 through 7, lever body 100 also has a pin aperture 106 for receiving cam follower pin 98 so that it may engage cam path 96 and move therein as lock lever 66 is pivoted by the movement of inner wire member 26, which results from the movement of handle 30 by the user of wheelchair 12. In the embodiment shown in the figures, one or more spacer members, such as first spacer 108 and second spacer 110 are utilized to provide sufficient space between locking assembly 20 and frame 14. In the preferred embodiment, first spacer 108 is sized to receive an end of axle 50, which passes through base plate 62 at axle cooperating aperture 68 shown in FIG. 8, and second spacer 110 is sized to receive a bolt 114 or other connector that passes through bolt aperture 116 in base plate 62, as also shown in FIG. 8. Cable stand 70 attaches to base plate 62 by connectors 118 received through stand apertures 120. The reduced diameter portion 90 of lock stub 64 is received in stub aperture 122, shown in FIG. 8.

Spring 82 is disposed around the second end 78 of locking pin 74 and both are received in an opening in the second end 92 of lock stub 64 through stub aperture 122 in base plate 62. The first end 88 of lock stub 64 is received in an opening in lever body 100 of lock lever 66 and connecting element 80 connects to the second end 78 of locking pin 74 in a manner that securely holds locking pin 74 in lock stub 64, even with spring 82 biasing first end 76 away from lock stub 64, while permitting lock lever 66 to pivot about lock stub 64 so as to move cam follower pin 98 through cam path 96. As cam follower pin 98 moves through cam path 96 away from base plate 62, due to the action of handle 30 moving from locked groove 40 to unlocked groove 42, lock lever 66 will pull first end 76 of locking pin 74 away from engagement with one of the apertures of locking rotor 52, thereby unlocking wheel 16 and allowing wheelchair 12 to move. As cam follower pin 98 moves through cam path 96 towards base plate 62, due to the action of handle 30 moving from unlocked groove 42 to locked groove 40, lock lever will rotate and push first end 76 of locking pin 74 towards engagement with one of the plurality of apertures of locking rotor 52, thereby locking wheel 16 and preventing movement of wheelchair 12. This rotating movement of lock lever 66 from the movement of handle 30 results in first end 76 of locking pin 74 being moved into or out of engagement with one of the locking apertures 54 on locking rotor 52, thereby preventing the common stuck locked condition that results from direct insertion into the locking aperture or slot of existing wheelchair wheel locks. As known to those skilled in the art, the various components of wheelchair wheel lock 10 of the present invention can be made out of a variety of different materials as may be suitable for use with wheelchairs. Such materials can include metals such as aluminum, plastics, composites and a variety of other materials.

In use, the user will operate handle 30 to cause inner wire member 26 to pivot lever handle 104 of lock lever 66 and pivot lever body 100 about lock stub 64. The rotating of lever body 100 moves cam follower pin 98 inside cam path 96 to cause the force of spring 82 to bias first end 76 of locking pin 74 into one of the plurality of locking apertures 54 of locking rotor 52 to lock wheel hub 48 and prevent movement of the wheelchair wheel 16. Opposite movement of the user's lever or other device will cause inner wire member 26 to rotate lever body 100 in the opposite direction and release the pressure on locking pin 74 to withdraw first end 76 of locking pin 74 from the locking aperture 54 of locking rotor 52. Because locking pin 74 is moved by rotation action of the cam mechanism, as described above, instead of direct insertion that is utilized with the prior art devices, the first end 76 of locking pin 74 will not be stuck inside locking aperture 54 of locking rotor 52 due to the force against the wheelchair wheel 16 causing a lateral force against first end 76 of locking pin 74 (which in prior art devices prevents first end 76 being withdrawn from locking aperture 54). In addition, the wheelchair wheel lock 10 of the present invention provides a narrower profile for wheelchair 12 which will make it easier to move and store.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A wheelchair wheel lock for a wheel of a wheelchair, comprising:
a lock operating mechanism attached to said wheelchair, said lock operating mechanism configured to be operated by an occupant of said wheelchair;
a cable having a first end and a second end, said first end of said cable operatively connected to said lock operating mechanism;
a locking rotor attached to a hub of said wheel, said locking rotor having a plurality of locking apertures; and
a locking assembly at said wheel of said wheelchair, said locking assembly operatively connected to said second end of said cable, said locking assembly comprising a locking pin operatively connected to a cam mechanism disposed on a base plate positioned substantially adjacent said locking rotor, said cam mechanism configured to extend said locking pin outwardly from said base plate into one of said plurality of locking apertures to lock said wheel or to withdraw said locking pin from said locking rotor so as unlock said wheel.

2. The wheelchair wheel lock according to claim 1, wherein said lock operating mechanism is configured with a handle connected to said first end of said cable.

3. The wheelchair wheel lock according to claim 1, wherein said base plate is substantially parallel to said locking rotor and said locking pin extends substantially perpendicular from said base plate to said locking apertures on said locking rotor.

4. The wheelchair wheel lock according to claim 1, wherein said cam mechanism comprises a lock stub on said base plate, said lock stub having a first end, a second end and a cam path disposed thereon, said locking pin received in said second end of said lock stub and configured to extend therefrom or retract therein by movement of a cam follower pin in said cam path.

5. The wheelchair wheel lock according to claim 4, wherein said cam mechanism further comprises a lock lever having a lever body and a lever handle, said first end of said lock stub received in said lever body, said lever body configured to pivot around said first end of said lock stub to move said cam follower pin in said cam path.

6. The wheelchair wheel lock according to claim 5, wherein said cam follower pin is attached to said lever body and said second end of said cable is attached to said lever handle such that the operation of said lock operating mechanism will pivot said lock lever and move said cam follower pin in said cam path to extend or retract said locking pin from engagement with one of said locking apertures.

7. The wheelchair wheel lock according to claim 6, wherein said locking pin has a first end for engagement with one of said locking apertures and a second end attached to a connecting element disposed through said lever body.

8. The wheelchair wheel lock according to claim 7, wherein said cam mechanism further comprises a spring about said locking pin generally at said second end of said locking pin, said spring biasing said first end of said locking pin toward said locking rotor.

9. The wheelchair wheel lock according to claim 1, wherein said base plate further comprises a cable stand for supporting said second end of said cable.

10. The wheelchair wheel lock according to claim 1, wherein said cam mechanism comprises a lock stub having a first end and a second end and said locking pin has a first end and a second end, said lock stub mounted at a stub aperture on said base plate, said first end of said locking pin configured to engage said one of said plurality of locking apertures, said second end of said locking pin received in said second end of said lock stub.

11. The wheelchair wheel lock according to claim 10, wherein said cam mechanism further comprises a cam path on said lock stub, a lock lever attached to said second end of said locking pin and pivotally engaged with said first end of said lock stub and a cam follower pin on said lock lever, said cam follower pin disposed in said cam path such that the pivotal movement of said lock lever moves said first end of said locking pin into or out of engagement with said one of said plurality of locking apertures.

12. A wheelchair wheel lock for a wheel of a wheelchair, comprising:
a lock operating mechanism attached to said wheelchair, said lock operating mechanism configured to be operated by an occupant of said wheelchair;
a cable having a first end and a second end, said first end of said cable operatively connected to said lock operating mechanism;
a locking rotor attached to a hub of said wheel, said locking rotor having a plurality of locking apertures; and
a locking assembly at said wheel of said wheelchair, said locking assembly operatively connected to said second end of said cable, said locking assembly comprising a locking pin operatively connected to a cam mechanism disposed on a base plate positioned substantially adjacent and parallel to said locking rotor, said cam mechanism comprising a lock stub having a cam path thereon and a lock lever having a cam follower pin disposed in said cam path, said lock lever pivotally disposed about one end of said lock stub and configured to move said cam follower pin in said cam path so as to extend said locking pin outwardly in a generally perpendicular direction from said base plate into one of said plurality of locking apertures to lock said wheel or to withdraw said locking pin from said locking rotor so as unlock said wheel.

13. The wheelchair wheel lock according to claim 12, wherein said second end of said cable is attached to said lock lever such that the operation of said lock operating mechanism will pivot said lock lever and move said cam follower pin in said cam path to move said locking pin into or out of engagement with one of said locking apertures.

14. The wheelchair wheel lock according to claim 12, wherein said base plate further comprises a cable stand for supporting said second end of said cable.

15. A locking assembly to lock a wheel of a wheelchair having a frame, comprising:
a base plate attached to said frame and positioned substantially adjacent to a locking rotor attached to a hub of said wheel, said locking rotor having a plurality of locking apertures;
a lock stub fixed to said base plate, said lock stub having a first end, a second end and a cam path thereon;
a locking pin having a first end and a second end, said second end of said locking pin disposed in said second end of said lock stub, said first end of said locking pin configured to engage one of said plurality of locking apertures; and
a lock lever pivotally disposed about said first end of said lock stub and connected to said second end of said locking pin, said lock lever having a cam follower pin in cooperative engagement with said cam path to engage or disengage said first end of said locking pin with said one of said plurality of said locking apertures.

16. The locking assembly according to claim 15, wherein said base plate is substantially parallel to said locking rotor and said locking pin extends substantially perpendicular from said base plate to said locking apertures on said locking rotor.

17. The locking assembly according to claim 15, wherein said locking lever is attached to a cable.

18. The locking assembly according to claim 15 further comprising a spring disposed at said second end of said locking pin in said second end of said lock stub, said spring configured to bias said first end of said locking pin toward said plurality of locking apertures.
